(19) United States
(12) Patent Application Publication
(10) Pub. No.: US 2007/0005705 A1
(43) Pub. Date: Jan. 4, 2007

(54) System and method of dynamically displaying an associated message in a message

(76) Inventor: Hung-Chih Yu, Taipei (TW)

Correspondence Address: RABIN & Berdo, PC, 1101 14TH STREET, NW, SUITE 500, WASHINGTON, DC, 20005, US

(21) Appl. No.: 11/154,717

(22) Filed: Jun. 17, 2005

(51) Int. Cl. G06F 15/16

(52) U.S. Cl. 709/206

(57) ABSTRACT

A System of dynamically displaying an associated message in a message employed in a handheld data processing device, including a multimedia database storing a plurality of sets of multimedia data, a keyword identification module capable of identifying the content of a draft message and a sent message based on a predetermined keyword list to generate a set of keyword information, a keyword search module searching a set of multimedia data corresponding to the set of keyword information from the multimedia database and an associated message prompt module generating the associated message based on the searched set of a set of multimedia data and displaying the associated message on the handheld data processing device.

### BACKGROUND OF THE INVENTION

1. Field of Invention

The present invention relates to a system and method of displaying an associated message employed in a handheld data processing device. Particularly, the present invention relates to a system and method of dynamically displaying an associated message in a message based on the content of a draft or sent message.

2. Related Art

A handheld data processing device, such as a personal digital assistant (PDA) and a mobile phone, possesses the advantage of small volume and good portability and hence becomes an indispensable electronic product in our daily life.

Today, the handheld data processing device has been highly developed in performances of operations and data storing and the like and hence many previously unworkable functions have been realized in the current handheld data processing device, such as a yellow page function and a graphic information system (GIS) function. Through the GIS, a user may locate a particular address or a building or perceive the current position the user is at, and the surrounding geographical environment. Through the yellow page, the user may perceive, for example, where a multitude of stores are and even get information associated with the current products having special prices.

Although the added function of information searching brings considerable convenience to the users, this function still leaves something in use to be improved. As an example, the handheld data processing device is typically equipped with a small screen, since it has to meet the requirements of slightness and compactness. For example, after reading a message “Let's meet in front of the A store at the B place at 19:00 p.m.”, the user wants to know where the A store and the B place are, and needs to search them through the yellow page or the GIS function. However, the user may undertake this searching task by entering an associated page only after ending the original message reading operation. Thus, an inconvenience is taking place.

### SUMMARY OF THE INVENTION

In light of the disadvantages, the present invention discloses a system and method of dynamically displaying an associated message in a message. With the system and method, a user may operate the associated message when editing a draft message or reading a receiving message sent by other user at a current message page without the need of leaving the current message page, by directly selecting the associated message on the current message page, since content of the message is monitored and identified, and the associated message is provided and displayed based on keywords in the monitored and identified message.

In accordance with the present invention, the system of dynamically displaying an associated message in a message comprises a multimedia database storing a plurality of sets of a set of multimedia data, a keyword identification module, capable of identifying the content of a draft message, and a sent message based on a predetermined keyword list to generate a set of keyword information, a keyword search module searching a set of multimedia data corresponding to the set of keyword information from the multimedia database and an associated message prompt module generating the associated message based on the searched set of a set of multimedia data and displaying the associated message.

With the execution of the system and method of displaying an associated message in a message in a handheld data processing device, the user may conveniently be benefited with a yellow page function or a GIS function without the troublesome need of leaving the current environment, when accessing a draft or sent message. Therefore, the handheld data processing device employing the system and method according to the present invention may be used in a more convenient way and satisfy the user's demand.

The other objects, features and implementations of the present invention will be explained in more detail below, with reference to the preferred embodiments in connection with the drawings.

### BRIEF DESCRIPTION OF THE DRAWINGS

The invention will become more fully understood from the detailed description given hereinbelow illustration only, and thus are not limitative of the present invention, wherein:

FIG. 1 is a schematic diagram of a system of dynamically displaying an associated message in a message employed in a handheld data processing device according to the present invention;

FIG. 2 is a flowchart of a method of dynamically displaying an associated message in a message employed in a handheld data processing device according to a first embodiment of the present invention;

FIG. 3 is a flowchart of a method of dynamically displaying an associated message in a message employed in a handheld data processing device according to a second embodiment of the present invention; and

FIG. 4 is a schematic diagram showing use of a handheld data processing device incorporating the system of dynamically displaying an associated message of a message.

### DETAILED DESCRIPTION OF THE INVENTION

A system of displaying an associated message in a message according to the present invention is suitably employed in a handheld data processing device, such as a personal digital assistant (PDA) and a mobile phone, and will be described below by taking the mobile phone as an example.

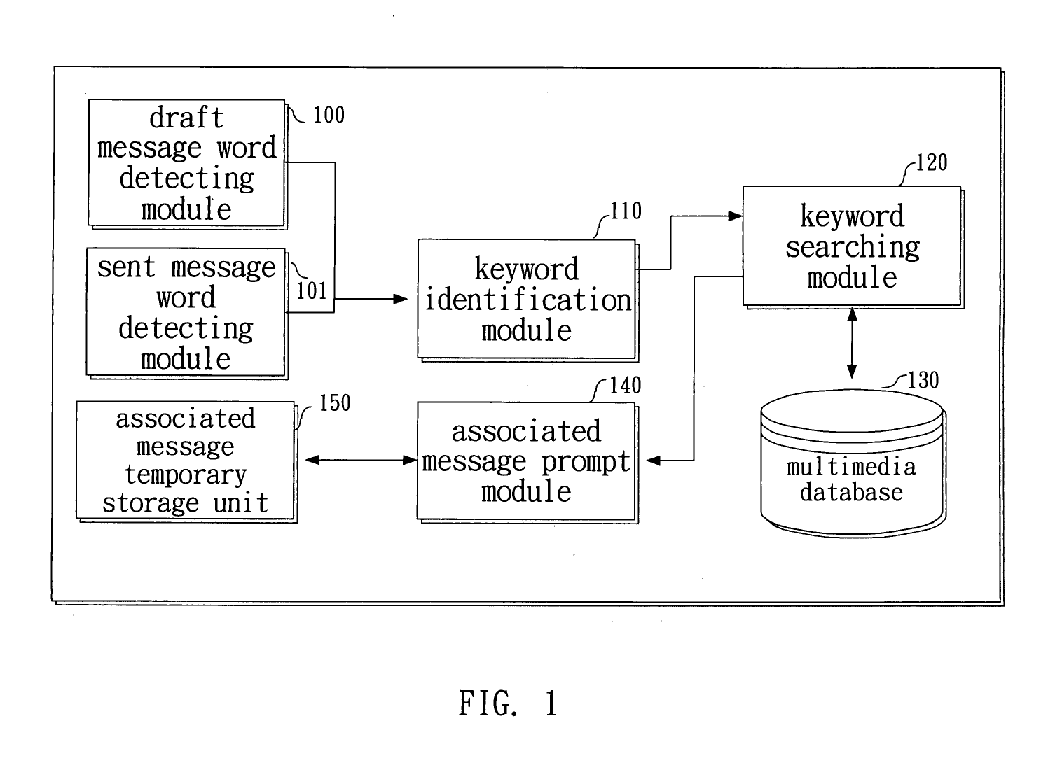

Referring to FIG. 1, the system of displaying an associated message in a message employed in a mobile phone comprises a draft message word detecting module 100, a sent message word detecting module 101, a multimedia database 130, a keyword identification module 110, a keyword searching module 120, an associated message prompt module 140 and an associated message temporary storage unit 150. The draft message word detecting module 100 are provided to monitor and control (parse) content of a locally inputted message. The sent message word detecting module 101 are used to detect if there is a keyword location data in a sent message. If a keyword location data exists in the sent message, a set of keyword information may be easily defined and thus operation time of the keyword identification module 110 (will be described below) may be considerably reduced. The multimedia database 130 stores a plurality of sets of a set of multimedia data comprising information of maps, stores, products and news. By type, the set of multimedia data may be categorized into textual data, pictorial data and audio data. The keyword identification module 110 is provided to generate a set of keyword information for a draft message or a sent message based on a predetermined keyword list. The keyword searching module 120 is used to search a set of multimedia data corresponding to the set of keyword information from the multimedia database 130, based on the set of keyword information. The associated message prompt module 140 is used to generate an associated message based on the set of multimedia information corresponding to the set of keyword information and display the generated associated message on the mobile phone. The associated message temporary storage unit 150 is used to temporarily store the associated message provided from the associated message prompt module 140.

The system of displaying an associated message in a message according to the present invention has been described as above. A method of displaying an associated message in a message according to the present invention will be described below. By implementation of the method, an associated message may be generated when a message is edited locally by a user so that the user may obtain information of maps, stores, products, news and the like.

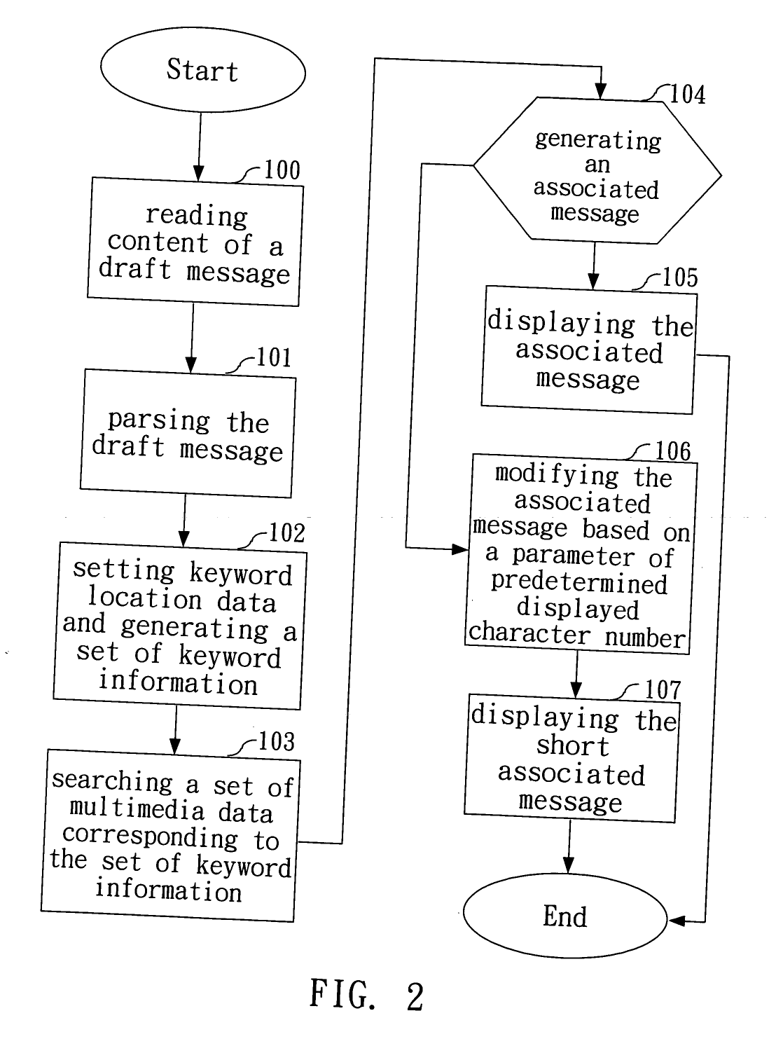

Referring to FIG. 2, a flowchart of the method according to a first embodiment of the present invention is illustrated therein, where the method is performed when a local draft message is edited. First, reading the content of a draft message (step 100). Next, monitoring and controlling (parsing) the draft message since the draft message is edited and changes continually in its content (step 101). Setting a keyword location data and generating a set of keyword information (step 102) and thus automatically adding the keyword location data into the draft message. Then, searching a set of multimedia data corresponding to the set of keyword information from a multimedia database (step 103). The set of multimedia data in the multimedia database may be information of maps, stores, products and news and may be categorized into textual data, pictorial data and audio data.

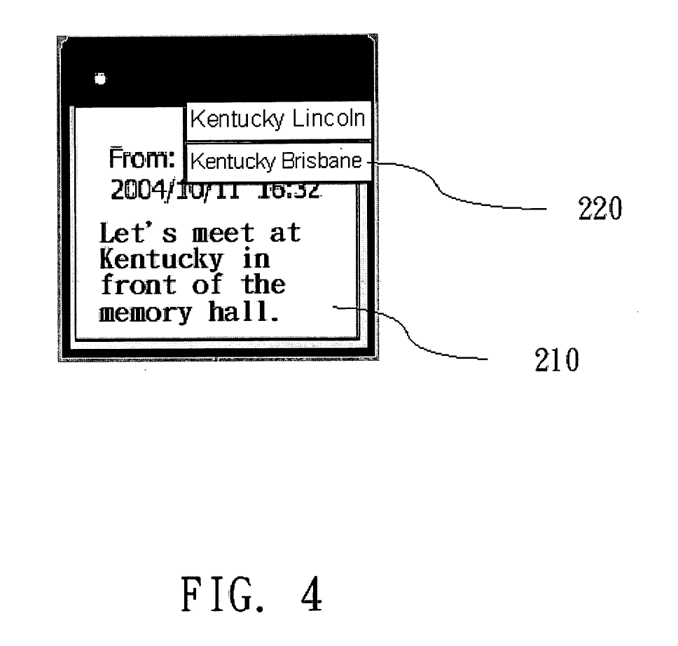

Thereafter, generating an associated message based on the set of multimedia data corresponding to the set of keyword information (step 104). Finally, displaying the associated message on the mobile phone (step 105) and the method ends. Since current mobile phones have different screen sizes and thus the associated message may not be wholly displayed in a single screen size, the associated message may be, after step 104, optionally modified, based on a parameter of a predetermined displayed character number into a short associated message (step 106). Next, displaying the short associated message 220 corresponding to the draft message 210 on the mobile phone (step 107), shown in FIG. 4, and the method ends.

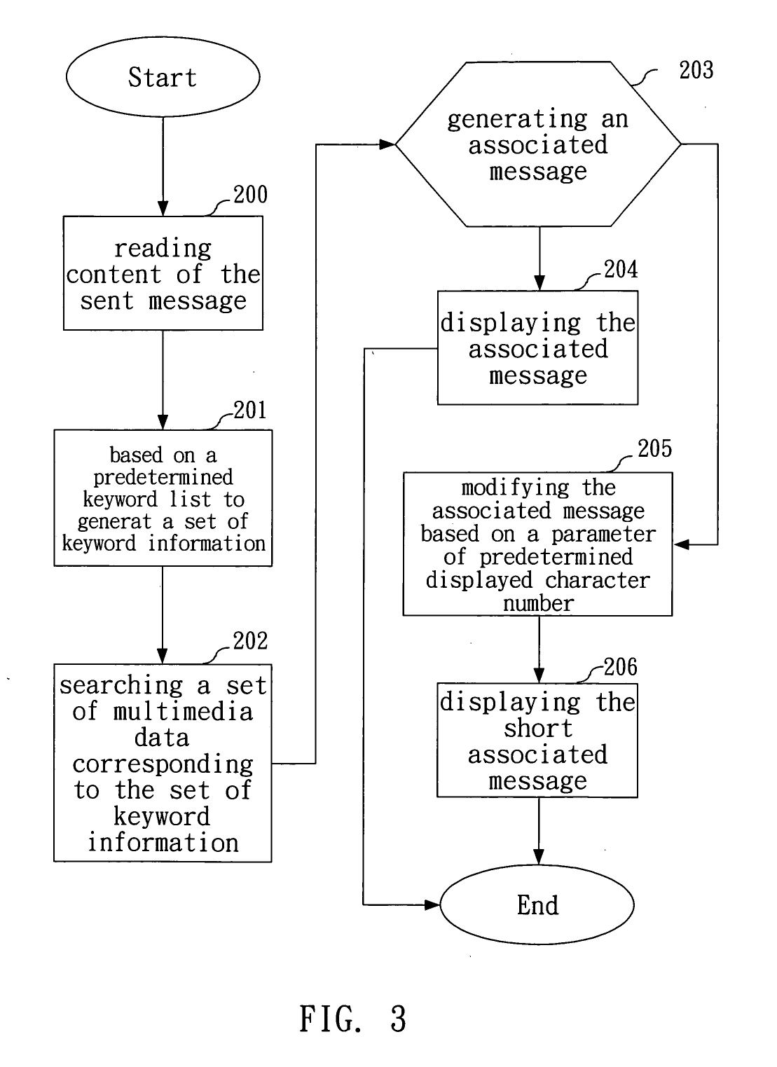

Referring to FIG. 3, a flowchart of the method according to a second embodiment of the present invention is illustrated therein, where the method is performed when a sent message is being received. First, reading the content of the sent message (step 200). Next, identifying the content of the distant message and searching a keyword location data based on a predetermined keyword list and thus generating a set of keyword information (step 201). Then, searching a set of multimedia data corresponding to the set of keyword information from a multimedia database (step 202). The set of multimedia data in the multimedia database may be information of maps, stores, products and news and may be categorized in textual data, pictorial data and audio data.

Thereafter, generating an associated message based on the set of multimedia data corresponding to the set of keyword information (step 203). Finally, displaying the associated message on the mobile phone (step 204) and the method ends. Since current mobile phones have different screen sizes and thus the associated message may not be wholly displayed in a single screen size, the associated message may be, after step 203, optionally modified based on a parameter of a predetermined displayed character number into a short associated message (step 205). Next, displaying the short associated message corresponding to the sent message on the mobile phone (step 206) and the method ends.

With the execution of the system and method of displaying an associated message in a message in a mobile phone, the user may conveniently be benefited with a yellow page function or a GIS function without the troublesome need of leaving the environment when accessing a draft or sent message. Therefore, the mobile phone employing the system and method according to the present invention may be used in a more convenient way and satisfy the user's demand.

While embodiments and applications of this invention have been shown and described, it would be apparent to those skilled in the art, having the benefit of this disclosure, that many more modifications than mentioned above are possible without departing from the inventive concepts herein. For example, the invention may be applied in a PDA or other handheld data processing devices other than the described mobile phone. The invention, therefore, is not to be restricted except in the spirit of the appended claims and their equivalents.

1. A system of dynamically displaying an associated message in a message employed in a handheld data processing device capable of sending a draft message and receiving a sent message, comprising:
a multimedia database storing a plurality of sets of multimedia data;
a keyword identification module capable of identifying content of a draft message and a sent message based on a predetermined keyword list to generate a set of keyword information;
a keyword search module searching a set of multimedia data corresponding to the set of keyword information from the multimedia database; and
an associated message prompt module generating the associated message based on the searched set of a set of multimedia data and displaying the associated message.

2. The system of claim 1, further comprising a draft message word detecting module used to parse content of the draft message which is being inputted.

3. The system of claim 1, further comprising a sent message word detecting module used to detect a keyword location data in the sent message.

4. The system of claim 1, further comprising an associated message temporal storage unit use to store the associated message.

5. The system of claim 1, wherein the set of multimedia data is selected from a group consisting of information of maps, stores, products, news and their combinations.

6. The system of claim 1, wherein the set of multimedia data is selected from a group consisting of textual data, pictorial data, audio data and their combinations.

7. A method of dynamically displaying an associated in a message executed in a handheld data processing device capable of sending a draft message, comprising the steps of:
reading content of the draft message;
searching a set of multimedia data corresponding to a set of keyword information from a multimedia database;
generating an associated message based on the set of multimedia data corresponding to the set of keyword information; and
displaying the associated message.

8. The method of claim 7, further comprising the steps of:
monitoring the content of the draft message; and
generating the set of keyword information based on a predetermined keyword list.

9. The method of claim 8, wherein the step of displaying the associated message further comprises the steps of:
generating a short associated message by modifying content of the associated message based on a parameter of predetermined displayed character number; and
displaying the short associated message.

10. The method of claim 8, wherein the associated message is textual data.

11. The method of claim 8, wherein the associated message is displayed in a color which a user easy to be prompted.

12. The method of claim 8, wherein the set of multimedia data is selected from a group consisting of information of maps, stores, products and news and their combinations.

13. The method of claim 8, wherein the set of multimedia data is selected from a group consisting of textual data, pictorial data and audio data and their combinations.

14. A method of dynamically displaying an associated in a message executed in a handheld data processing device capable of receiving a sent message, comprising the steps of:
reading content of the sent message;
identifying the content of the sent message and generating a set of keyword information based on a predetermined keyword list;
searching a set of multimedia data corresponding to a set of keyword information from a multimedia database;
generating an associated message based on the set of multimedia data corresponding to the set of keyword information; and
displaying the associated message.

15. The method of claim 14, wherein the step of displaying the associated message further comprises the steps of:
generating a short associated message by modifying content of the associated message based on a parameter of predetermined displayed character number; and
displaying the short associated message.

16. The method of claim 14, wherein the associated message is textual data.

17. The method of claim 14, wherein the associated message is displayed in a color which a user easy to be prompted.

18. The method of claim 14, wherein the set of multimedia data is selected from a group consisting of information of maps, stores, products and news and their combinations.

19. The method of claim 14, wherein the set of multimedia data is selected from a group consisting of textual data, pictorial data and audio data and their combinations.
